(19) United States
(12) Patent Application Publication
(10) Pub. No.: US 2008/0152899 A1
(43) Pub. Date: Jun. 26, 2008

(54) Reducing electrostatic discharge ignition sensitivity of MIC materials

(75) Inventors: Shubhra Gangopadhyah, Columbia, MO (US); Rajagopalan Thiruvengadathan, Columbia, MO (US); Andrey Bezmelnytsin, Columbia, MO (US); Steven Apperson, Columbia, MO (US); Keshab Gangopadhyay, Columbia, MO (US)

Correspondence Address: GREER, BURNS & CRAIN, 300 S WACKER DR, 25TH FLOOR, CHICAGO, IL, 60606, US

(73) Assignee: The Curators of the University of Missouri

(21) Appl. No.: 12/001,296

(22) Filed: Dec. 11, 2007

Related U.S. Application Data
(60) Provisional application No. 60/874,089, filed on Dec. 11, 2006.

(51) Int. Cl. B05D 7/00; B32B 5/16

(52) U.S. Cl. 428/327; 427/213.3

(57) ABSTRACT

The invention provides metastable intermolecular composites that have good thermite properties while also being relatively insensitive to electrostatic discharge ignition. A preferred embodiment metastable intermolecular composite has a metal oxide nanostructure, which can be coated with an energetic polymer via a molecular linker or loaded with a gas generating polymer. Metal fuel nanoparticles coated with an energetic polymer via a molecular linker are closely associated with said metal oxide nanostructure. Methods of making metastable intermolecular composites are also provided by the invention.

### PRIORITY CLAIM AND REFERENCE TO RELATED APPLICATION

The application claims priority under 35 U.S.C. §119 from prior provisional application Ser. No. 60/874,089, which was filed Dec. 11, 2006.

### STATEMENT OF GOVERNMENT INTEREST

This invention was made with government support under Contract Number awarded by W15QKN-06-D-0031 awarded by the Department of Defense. The government has certain rights in the invention.

### FIELD

A field of the invention is energetic materials, and particularly energetic nanoparticle materials, also referred to as metastable intermolecular composites (“MIC”). Example applications of the invention include military, mining, demolition, detonation devices, fuses, smart ammunitions, propellant initiators, propellant systems, and power generation devices.

### BACKGROUND

Handling of metastable intermolecular composites can be very difficult. The nanoparticles have surface charges that can ignite the metastable intermolecular composites from static electricity. Ignition of the nanoparticles at inopportune times causes loss of efficacy when the desired ignition occurs. There are also safety concerns regarding handling of these composites if they can ignite at any time. Reducing electrostatic discharge ignition energy of metastable intermolecular composites is an important issue for expanding the practical capabilities and applications of the metastable intermolecular composites.

Typical metastable intermolecular composites include a porous metal oxide oxidizer, such as Fe₂O₃ and CuO based porous or nanostructures mixed with fuel metal nanoparticles, such as Al nanoparticles. Oxidizer and fuel nanostructures possess very reactive surfaces that can cause a potential problem of accidental ignition during handling. Reducing the electrostatic discharge ignition sensitivity of metastable intermolecular composites is therefore important, but competes with the concern of maintaining the thermite properties of the metastable intermolecular composites. Stability with good thermite performance has proven difficult to obtain.

Others have tried to reduce ignition sensitivity of metastable intermolecular composites materials by coating the nanoparticles with polymer coatings. In some cases, the coating changed the surface sufficiently to render many of the good properties negligible. Other coatings retained some of the benefits of nanoenergetic materials, but made the burn uncontrollable. Another problem associated with the use of nanoenergetic materials is incomplete coating of all nanoparticles. Where some particles fail to come into contact with the coating material, the nanoparticles retain their original ignition sensitivity. Even coated particles can be ignited if the burn is started by uncoated nanoparticles. If uncoated nanoparticles remain after coating treatment, they should not be permitted to remain with the coated nanoparticles.

In such metastable intermolecular composites, surface charge may develop from defects in the materials such as vacancies, interstitials and electronic carriers in the bulk crystalline materials. Under the influence of electrical fields, surface charge present on the ionic crystal develops a space charge layer. The negative charge developed in an oxidizer particle is assumed to be due to partially bonded oxygen atoms at the particle surface. The neutral hydroxyl group bonded at the particle surface (M-OH) also plays a very important role in the chemical charge equilibrium of material. However, if a charge imbalance exists between the surface charge on the material and the static electric field, the electrostatic energy will try to quickly override the charge neutrality in the total volume of bulk material. This static sensitive material may cause accidental ignition that converts mechanical, chemical, electrical, or other energy of the charged particles into thermal energy and accelerates the rate of decomposition reactions. When crystalline oxidizer and fuel are in intimate contact, in case of high oxygen availability in the metal oxide, excess electrons in the fuel phase provided by the oxide imposes a negative surface charge on the oxide thus give rise to an electric double layer in the metallic and oxide part of the interface. In metastable intermolecular composite materials nanoparticles of aluminum are preferred for fuel over micron size particles as they provide higher reactivity due to their larger surface area. These composite materials are highly sensitive to electrostatic discharge (ESD) ignition, however.

Mixing of fluoropolymers such as Teflon® with metastable intermolecular composites has also been investigated to attempt to reduce electrostatic discharge ignition sensitivity. Past attempts to use fluoropolymers to reduce electrostatic discharge ignition sensitivity have, however used simple mixing of Teflon® with the metastable intermolecular composites, typically during the formation of the metastable intermolecular composites. Fluoropolymers do not bond easily, and the result of these past efforts have been that thermite properties have been significantly reduced when the amount of fluoropolymer used has been sufficient to provide a meaningful reduction in electrostatic discharge ignition sensitivity.

Some attempts have been made to coat Al-nanoparticles (20-50 nm) and these nanoparticles were coated with fluropolymer (Teflon®) at 18% (mass percent level. “Hazard Characterization of Aluminum Nanopowder Compositions” D. E. G. Jones, R. Turcotte, R. C. Fouchard, Q. S. M. Kwok, A. -M. Turcotte, and Z. Abdel-Quader, Propellants, Explosives, Pyrotechnics 28 (2003) 120. Originally, these particles had electrostatic discharge ignition energy of 0.006 J. After coating, the electrostatic discharge ignition energy value was increased to >0.156 J. That work also investigated another polymer, glycidal azide polymer (GAP), which when mixed with Al-nanoparticles in a ratio of 50:50 did not show sensitivity towards electrostatic discharge ignition energy, impact and friction.

### SUMMARY OF THE INVENTION

The invention provides metastable intermolecular composites that have good thermite properties while also being relatively insensitive to electrostatic discharge ignition. A preferred embodiment metastable intermolecular composite has a metal oxide nanostructure, which can be coated with an energetic polymer via a molecular linker or loaded with a gas generating polymer. Metal fuel nanoparticles coated with an energetic polymer via a molecular linker are closely associated with said metal oxide nanostructure. Methods of making metastable intermolecular composites are also provided by the invention.

### DETAILED DESCRIPTION OF THE PREFERRED EMBODIMENTS

Embodiments of the invention provide metastable intermolecular composites with reduced electrostatic discharge ignition sensitivity. Metastable intermolecular composites of the invention include metal fuel nanoparticles coated with an energetic polymer molecularly linked by perfluorooctal mono-functional trimethoxysilane (FSM). With bonding of the energetic polymer, e.g. Teflon® or THV 220A, small amounts can be used to preserve thermite properties of the metastable intermolecular composites, while still achieving a significant reduction in electrostatic discharge ignition sensitivity of the metastable intermolecular composites.

A preferred embodiment metastable intermolecular composite of the invention is a metal oxide nanoparticle and metal fuel nanostructure composite coated, i.e., encapsulated at the nanoscale, uniformly with the energetic polymer such as Teflon and THV 220A. The metal fuel particles are also coated with an energetic polymer, preferably Teflon® or THV 220A. Preferred composites are Fe₂O₃ or CuO based nanostructured or porous materials mixed with Al nanoparticles having and energetic polymer coating molecularly linked to the Al nanoparticles. Compared to nanostructured composites lacking the metal nanoparticle molecularly linked coating, the composites of the invention have significantly reduced electrostatic discharge ignition sensitivity.

The invention also provides synthesis methods for forming metastable intermolecular composites with reduced electrostatic discharge ignition sensitivity. Teflon® is molecularly linked to and coats the fuel nanostructures, which are preferably Al nanoparticles, and the metal oxide structure to reduce the electrostatic discharge ignition sensitivity. The composite is further improved where coated particles are separated during synthesis from uncoated particles. Coating of the nanoparticles with a hydrophobic fluoropolymer energetic polymer allows uncoated particles to be separated from coated particles using a simple phase separation. When the amount of uncoated particles is reduced to a negligible amount, the coated particles are able to he handled with a low risk of premature ignition. This assures that the maximum energy is given off at the desired ignition time.

A preferred method of treating nanoparticles to reduce their electrostatic discharge ignition sensitivity includes preparing a solution of an energetic polymer dissolved in a suitable solvent. The nanoparticles are first dispersed in a non-aqueous solvent. The dispersed nanoparticles are contacted with an aqueous phase having a pH greater than about 8.0-9.0. The non-aqueous solvent is permitted to separate from the aqueous phase. The uncoated nanoparticles contacts the aqueous phase and the coated nanoparticles are recovered from the non-aqueous phase.

A preferred embodiment method of treating nanoparticles to reduce their electrostatic discharge ignition sensitivity includes steps of preparing a solution of an energetic polymer in a solvent; coating nanoparticles with the energetic polymer via a molecular linker; dispersing the nanoparticles in a non-aqueous solvent; contacting the dispersed nanoparticles with an aqueous phase having a pH around 8-9; allowing the non-aqueous solvent to separate from the aqueous phase; and recovering uncoated nanoparticles from the aqueous phase and recovering the coated nanoparticles from the non-aqueous phase. A preferred method of forming a metastable intermolecular composite prepares metal nanoparticles by these steps and then includes steps of preparing metal oxide nanostructures coated with the energetic polymer; assembling the metal nanoparticles and the metal oxide nanostructures to form the metastable intermolecular composite. Preferred energetic polymers are THV220A or Teflon®, which are preferably molecular linked via perfluorooctal mono-functional trimethoxysilane (FSM).

A preferred method of forming a metastable intermolecular composite includes steps of coating Al nanoparticles an energetic polymer binder via a molecular linker; separating well-coated particles from uncoated and poorly coated particles using solute leaching from the two immiscible contacting solvent phases; preparing metal oxide nanostructures coated with energetic polymer; and assembling the metal nanoparticles and the metal oxide nanostructures to form the metastable intermolecular composite.

A preferred method of forming a metastable intermolecular composite, includes steps of dispersing and sonicating metal nanoparticles in a solution; adding perfluorooctal mono-functional trimethoxysilane (FSM) to the dispersion of metal nanoparticles and coating the metal nanoparticles with FSM 660 using a bath sonicator drying the coated particles; dispersing the coated nanoparticles in a fluoropolymer solution and coating the FSM coated particles with fluoropolymer using a bath sonicator; and drying the coated particles: and assembling the metal nanoparticles and the metal oxide nanostructures to form the metastable intermolecular composite.

A preferred method of forming a metastable intermolecular composite includes steps of forming CuO nanorods; washing the CuO nanorods in acidic medium; treating the acid washed nanorods with plasma to form hydroxyl groups on the surface, coating the acid washed and then plasma treated CuO nanorods with perfluorooctal mono-functional trimethoxysilane (FSM) through silanization treatment and 5 wt. % THV 220A; and combining the coated CuO nanorods with coated Al nanoparticles.

A preferred metastable intermolecular nanoenergetic composite of the invention includes metal oxide nanostructure coated with an energetic polymer molecularly linked to the metal oxide nanostructure and metal fuel nanoparticles coated with an energetic polymer molecularly linked to the metal fuel nanoparticles and closely associated with said metal oxide nanostructure. IN preferred embodiments, the molecular linker is perfluorooctal mono-functional trimethoxy silane (FSM). Preferred energetic polymers are Teflon® or THV 220A. In another preferred embodiment, the oxide is not coated with an energetic polymer, but is porous Fe₂O₃ loaded with the gas generating AAMCAB polymer and the Al nanoparticles are coated with THV or Teflon® with FSM as a molecular linker.

Sample embodiment metastable intermolecular composites prepared in experiments demonstrated that the required electrostatic discharge ignition energy of the composite prepared according to the invention was higher than as-synthesized oxidizer mixed with commercially available Al-nanoparticles. For example, an electrostatic discharge ignition energy of 31.5 mJ was obtained for the composites prepared using coated and separated particles as against the 0.98 mJ obtained for one prepared without the energetic polymer coating. The performance of the MIC materials prepared using coated with energetic polymer and then phase separated in terms of combustion wave speed, is relatively comparable to that of uncoated MIC materials. In preferred embodiments, Al fuel nanoparticles and the metal oxide are coated with FSM 660 (Perfluorooctal mono-functional trimethoxy silane) and then THV 220A or Teflon®.

Preferred embodiments of the invention will now be discussed with respect to the drawings. The drawings may include schematic representations, which will be understood by artisans in view of the general knowledge in the art and the description that follows. Preferred embodiments will be discussed with respect to experimental example nanocomposites and methods of fabrication, while artisans will appreciate the broader commercial applications and scale-ups of the experiments that are within the scope of the invention.

Commercially available Al nanoparticles have wide range of size distribution, which affects the properties of energetic composites. As an example, is during experiments many particles of 10-180 nm size from the TEM (transmission electron microscopy of Al nanoparticles of average particle size of 80 nm (obtained from Nanotechnology, Inc., Austin, Tex.) were observed. The smaller Al particles possess lower active aluminum content and higher ESD ignition sensitivity, whereas the bigger particles exhibit higher active Al content and lower electrostatic discharge ignition sensitivity. When Al with a broad particle size distribution is used with an oxidizer (as is typical since commercially available Al nanoparticles exhibit a wide size distribution), energetic performance can be compromised, and the handling capability of the composites is lost because of high electrostatic discharge ignition sensitivity.

In preferred embodiments, a esoporous Fe₂O₃ is used as an oxidizer in metastable intermolecular composites formulations and is coated with FSM 660 and then THV 220A or Teflon®. Metal fuel nanoparticles, preferably Al-nanoparticles are also coated with FSM as a molecular linker and then THV 220A or Teflon®.

Experiments were conducted and the electrostatic discharge ignition energy was measured. In one experiment, mesoporous Fe₂O₃ was first prepared and then infiltrated with Acrylamidomethyl cellulose acetate butyrate (AAMCAB) to realize tailored characteristics of the resultant composite. To reduce electrostatic discharge sensitivity of the energetic composite, Al nanoparticles were precoated with the energetic polymer, before mixing with the modified Fe₂O₃ oxidizer.

AAMCAB was obtained from Aldrich, and used as received. About 5-20 Wt. %. of AAMCAB with respect to porous iron oxide mass was dissolved in acetone. To this solution, Fe₂O₃ was added and the mixture was sonicated for 2 hrs and left undisturbed for 12 hours. After that, the mixture was dried at about 80° C. to remove the solvent. Energetic composites were then prepared by mixing with Al nanoparticles, both plain particles and particles that had been coated according to the invention with energetic polymers.

Table 1 summarizes the ESD energy for the porous Fe₂O₃ gel-based composites. The values show gradual increase in ESD energy when the porous gel was modified with the polymer and mixed with increasing weight percent of THV220A coated Al nanoparticles. ESD energy of 20 mJ was obtained for the composite prepared with porous gel loaded with 20% AAMCAB and then mixed with Al (120 nm) particles coated with 20% THV 220A polymer.

TABLE 1
Summary of ESD energy for Mesoporous Fe₂O₃—Al MIC materials.

| | | ESD |
|---|---|---|
| | | Energy |
| S. No | Composite Type (Sol-gel) | (mJ) |
| 1 | Fe₂O₃ Sol-gel + uncoated Al (80 nm) | 0.35 |
| 2 | Mesoporous Fe₂O₃ loaded with 20% AAMCAB + | 0.98 |
| | uncoated Al (120 nm) | |
| 3 | Mesoporous Fe₂O₃ loaded with 20% AAMCAB + 5% | 4.58 |
| | THV 220A coated Al (120 nm) | |
| 4 | Mesoporous Fe₂O₃ loaded with 20% AAMCAB + 10% | 10.40 |
| | THV 220A coated Al (120 nm) | |
| 5 | Mesoporous Fe₂O₃ loaded with 20% AAMCAB + 20% | 20 |
| | THV 220A coated Al (120 nm) | |

Note:
THV 220 A was coated to Al nanoparticles always via a molecular linker namely FSM 660.

In another experiment, CuO nanorods were coated with FSM 660 and then with 5 wt. % THV 220A and then mixed with 20 wt. % THV 220A coated Al nanoparticles. Prior to FSM coating, these CuO nanorods underwent a plasma treatment during which hydroxyl groups were formed on the surface. These surface hydroxyl groups facilitates to bind FSM to CuO surface through a process referred to as silanization. The electrostatic discharge ignition energy of this MIC composition is about 3.6 mJ. Despite coating, the sensitivity of CuO—Al composite to ESD is not reduced very much.

Potentiometric titrations to estimate the point of zero charge reveal that CuO nanorods are negatively charged particles. Washing these nanorods in acidic medium (pH=5-6) can neutralize the negatively charged surface. During coating of these acid washed CuO nanorods with energetic fluoropolymers, it is useful to prevent the surface from becoming charged again. This can be achieved as follows.

CuO nanorods are first washed in acidic medium (e.g., nitric acid diluted in water to get a desired pH of about 5.5) followed by coating with FSM 660 and 5 wt. % THV 220A. Prior to FSM coating, these acid-washed CuO nanorods underwent a plasma treatment during which hydroxyl groups were formed on the surface. These surface hydroxyl groups facilitates to bind FSM to CuO surface through a process referred to as silanization. These coated nanorods are mixed with 20 wt. % THV 220A coated Al nanoparticles. The electrostatic discharge ignition energy measured for composite prepared experimentally according to this procedure is about 31 mJ as against 0.16 mJ measured for uncoated MIC formulation. The acid washing and subsequent coating is very effective reduce the ESD sensitivity of CuO—Al MIC material.

During coating, uniformity can be increased by reducing charge imbalance with an antistatic surfactant. For this purpose, EDTA (ethylene diamine tetraacetic acid) can be useful because it can reduce the surface charge of material, while maintaining zeta potential of a solution, which is important for dispersion of the powders. EDTA is also a chelating agent for metal ions. An EDPA passivation layer on Al-nanoparticles is expected to chelate with the surface positive charge of Al-nanoparticles. In case of Al-nanoparticles, positive charge is difficult to neutralize with alkali because it will diffuse through porous alumina passivation layer present on Al and it will react to form aluminum hydroxide. When Al-nanoparticles come in contact with EDTA solution, chelation will nullify the charge present on Al-particles.

In another approach, conductive carbon filler can be incorporated in polymer layer to dissipate charge more effectively. In this, however, if conductive layer is not uniform then, tribocharging can create trapped charges that can not be dissipated. It is possible to sandwich a conductive polymer (CP) layer between Al-nanoparticles and inherently dissipative polymer (IDP). For example, apoly(vinylpyrrolidone) (CP) layer can be placed between Al-particles and glycidalazide polymer (IDP) layers. This can facilitate charge transfer from the nanoparticles to the surface and its dissipation in a more efficient way. Encapsulation/coating can follow with these modifications.

To achieve Teflon® coating (encapsulation) of Al nanoparticles, the nanoparticles were first dispersed in 2-propanol and by sonicating in a sonic bath for six hours. Perfluorooctal mono-functional trimethoxy silane in a high boiling point fluorinated solvent (commercially known as FSM 660) provides low surface energy to oxide surfaces and good adhesion for fluoropolymers 1 wt. % of Fluorosyl FSM 660 was added to the dispersion of Al nanoparticles and this solution was again sonicated for two hours to achieve uniform coating of FSM 660-4. The coated particles are dried at 95° C. for two hours. These particles were again redispersed in teflon (TF^{AF}) solution. For this purpose, appropriate amounts of as-purchased TF^{AF} beads (1, 2, 4 and 10 wt. % with respect to mass of Al nanoparticles) from DuPont were first dissolved in a fluorocarbon solvent termed Fluorinert FC-75, manufactured by 3M Corporation, St. Paul, Minn. After sonicating the resulting solution for three hours, the samples were dried at 140° C., resulting in 1 wt. % Teflon® coated Al nanoparticles.

The electrostatic discharge ignition sensitivity of the Teflon® coated particles was measured. Uncoated Al nanoparticles have a very low electrostatic discharge ignition energy of 0.98 mJ. On the other hand Al nanoparticles coated with 1 and 2% of Teflon® have 2.6 and 4.7 mJ. With increasing Teflon weight % to 4 and 10%, the electrostatic discharge ignition energy increases to 25 mJ and 60 mJ, respectively. Testing revealed that all the nanoparticles may not be coated completely, especially with lower weight percents of Teflon®. Achieving uniform coating with lower weight percent of Teflon/THV220A are preferred to sustain the performance of MIC materials. The performance will be drastically reduced if the coatings are thick as combustion processes during the energetic reaction are diffusion limited and affected by mass transport and also the interfacial contacts are bound to decrease with thicker coatings. This demonstrates the importance of the present invention for achieving uniform thinner coatings with lower weight percent of fluoropolymers. Phase separation of uncoated nanoparticles from coated nanoparticles phase separation of the coated from uncoated and/or partially coated particles provides the ability to have high electrostatic discharge ignition energy particles that still retain good thermite properties.

To separate and achieve high electrostatic discharge ignition energy particles and composites using the particles, an aqueous solution of slightly alkaline pH (8-9) was directly added to a solution containing unseparated, coated nanoparticles in FC 75 solution. Those nanoparticles coated completely with Teflon® are hydrophobic and hence come to the top surface while the uncoated and partially coated particles are attracted to the water phase. The top phase is hence limited to the coated while the bottom phase refers to the uncoated or partially coated nanoparticles.

The electrostatic discharge ignition energy was measured again for the dried Al nanoparticles from the top and bottom phases separately. The ESD values shown in clearly revealed that the Al nanoparticles collected from the top fraction after phase separation show higher ESD energy and, this was true for different weight percent of Teflon® coating.

Various composites containing CuO nanorods and Al-nanoparticles were prepared using the procedures outlined in our earlier publications. The ESD ignition energy of these composites was measured using the standard operating procedure as per the MIL_STD and the results obtained are given in Table 2.

TABLE 2
ESD ignition energies of various CuO nanorod based composites.

| | | | | Material |
|---|---|---|---|---|
| | | ESD | Burn | Peak |
| | | Energy | rate | Pressure |
| Sample No. | Composite | (mJ) | (m/s) | (MPa) |
| 1 | CuO nanorods + Al (80 nm) | 0.16 | 1500 | 1.9 |
| 2 | CuO nanorods + 1 wt. % teflon coated | 1.4 | 1250 | 2.15 |
| | Al(80 nm) particles | | | |
| 3 | CuO nanorods + 2 wt. % teflon coated Al | 2.6 | 900 | 2.93 |
| | (80 nm) nanoparticles | | | |
| 4 | CuO nanorods + 4 wt. % teflon coated Al | 15 | 650 | 5.68 |
| | (80 nm) nanoparticles | | | |
| 5 | CuO nanorods + 10 wt. % teflon coated Al | 45 | 550 | 9.2 |
| | (80 nm) nanoparticles | | | |
| 6. | CuO nanorods plasma treated, then FSM | 3.6 | 300 | 10 |
| | 660 coated and 5% THV 220A coated + 20% | | | |
| | THV 220A coated Al nanoparticles | | | |
| 7. | CuO nanorods acid washed, plasma | 31 | 300 | 12 |
| | treated, FSM coated and then 5% THV | | | |
| | 220A coated + 20% THV 220A coated Al | | | |
| | nanoparticles | | | |

Note:
All Al nanoparticles were coated with FSM 660 prior to coating with THV 220A.

The composite of well-mixed CuO nanorods and Al-nanoparticles (avg. size 80 nm) shows very low ESD ignition energy of 0.16 mJ. It is clearly seen that the ESD energy of nanothermites formed with Teflon® coated Al nanoparticles is lower than that measured for Al nanoparticles alone coated with Teflon® having corresponding weight percent. This is possibly due to the surface charges on uncoated CuO nanorods. However, the ESD energy of nanothermites formed by mixing uncoated Al and uncoated CuO nanorods is less than 0.16 mJ. Thus, Teflon® coating of Al nanoparticles with the invention significantly reduces the sensitivity to ignition of the metastable intermolecular composite. The obtained combustion speeds (burn rate) and material pressure are also summarized in Table 2. The burn rate gradually decreases for metastable intermolecular composite formed by mixing CuO nanorods with Teflon® coated Al nanoparticles as given in Table 2. This is possibly due to the increased diffusion path owing to the Teflon Coating®. Thus, it takes a longer time for the self-propagating combustion reaction to proceed. The pressure generated during the thermite reaction was also measured simultaneously by placing pressure sensors and the pressure shows an increasing trend with increasing weight percent of Teflon® coating as expected. Thus, there is certainly a trade-off between electrostatic discharge ignition sensitivity and combustion speed. As shown above, the invention provides energetic composites that have sufficiently high electrostatic discharge ignition energy levels while still maintaining good thermite properties.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A method of treating nanoparticles to reduce their electrostatic discharge ignition sensitivity, the method comprising steps of:
preparing a solution of an energetic polymer in a solvent;
coating nanoparticles with the energetic polymer via a molecular linker;
dispersing the nanoparticles in a non-aqueous solvent;
contacting the dispersed nanoparticles with an aqueous phase having a pH around 8-9;
allowing the non-aqueous solvent to separate from the aqueous phase; and
recovering uncoated nanoparticles from the aqueous phase and recovering the coated nanoparticles from the non-aqueous phase.

2. A method of forming a metastable intermolecular composite, the method comprising:
preparing metal nanoparticles according to the method of claim 1;
preparing metal oxide nanostructures coated with the energetic polymer; and
assembling the metal nanoparticles and the metal oxide nanostructures to form the metastable intermolecular composite.

3. The method of claim 2, wherein the energetic polymer is THV220A or Teflon® and the molecular linker is perfluorooctal mono-functional trimethoxysilane (FSM).

4. A method of forming a metastable intermolecular composite, the method comprising:
coating Al nanoparticles an energetic polymer binder via a molecular linker;
separating well-coated particles from uncoated and poorly coated particles using solute leaching from the two immiscible contacting solvent phases;
preparing metal oxide nanostructures coated with energetic polymer; and
assembling the metal nanoparticles and the metal oxide nanostructures to form the metastable intermolecular composite.

5. A method of forming a metastable intermolecular composite, the method comprising:
dispersing and sonicating metal nanoparticles in a solution;
adding perfluorooctal mono-functional trimethoxysilane (FSM) to the dispersion of metal nanoparticles and coating the metal nanoparticles with FSM 660 using a bath sonicator.
drying the coated particles;
dispersing the coated nanoparticles in a fluoropolymer solution and coating the FSM coated particles with fluoropolymer using a bath sonicator; and
drying the coated particles: and
assembling the metal nanoparticles and the metal oxide nanostructures to form the metastable intermolecular composite.

6. The method of claim 5, wherein the fluoropolymer essentially consists of Teflon®.

7. A method of forming a metastable intermolecular composite, the method comprising:
forming CuO nanorods;
washing the CuO nanorods in acidic medium;
treating the acid washed nanorods with plasma to form hydroxyl groups on the surface
coating the acid washed and then plasma treated CuO nanorods with perfluorooctal mono-functional trimethoxysilane (FSM) through silanization treatment and 5 wt. % THV 220A; and
combining the coated CuO nanorods with coated Al nanoparticles.

8. A metastable intermolecular nanoenergetic composite, the composite comprising:
metal oxide nanostructure;
metal fuel nanoparticles coated with an energetic polymer molecularly linked to the metal fuel nanoparticles and closely associated with said metal oxide nanostructure.

9. The composite of claim 8, wherein the metal oxide nanostructure is coated with an energetic polymer molecularly linked to the metal oxide nanostructure.

10. The composite of claim 9 wherein
perfluorooctal mono-functional trimethoxy silane (FSM) molecularly links said energetic polymer to said metal fuel nanoparticles and to said metal oxide nanostructure.

11. The composite of claim 9, wherein the energetic polymer comprises Teflon® or THV 220A.

12. The composite of claim 8, wherein the metal oxide nanostructure comprises porous Fe₂O₃ loaded with AAMCAB polymer and the Al nanoparticles are coated with THV or Teflon® with FSM as a molecular linker.
